(19) United States
(12) Patent Application Publication
(10) Pub. No.: US 2016/0052527 A1
(43) Pub. Date: Feb. 25, 2016

(54) VEHICLE HAVING A GAS-SUCTIONING DEVICE

(71) Applicant: SIEMENS AKTIENGESELLSCHAFT, Munchen (DE)

(72) Inventor: ANDREAS DENKER, WUPPERTAL (DE)

(21) Appl. No.: 14/781,373

(22) PCT Filed: Mar. 21, 2014
(86) PCT No.: PCT/EP2014/055671

§ 371 Date: Sep. 30, 2015

(30) Foreign Application Priority Data
Apr. 2, 2013 (DE) 10 2013 205 780.6

(51) Int. Cl. B61D 27/00; G08B 17/10; B60H 1/24

(52) U.S. Cl. CPC B61D 27/009; B60H 1/243; B60H 1/248; G08B 17/10

(57) ABSTRACT

A vehicle, in particular a rail vehicle, includes a gas-suctioning device for suctioning gas located in the vehicle. At least one section of a suctioning line of the gas-suctioning device is routed through a luggage rack element attached in the interior of the vehicle, is held on the luggage rack element or formed by the luggage rack element. An assembly having a gas-suctioning device and a method for operating a gas-suctioning device are also provided.

The invention relates to a vehicle, in particular a rail vehicle, having a gas-suctioning device for suctioning gas (for example smoke gas or smoke, respectively) which is located in the vehicle, in particular for employment in a smoke-detection device. In other words, the gas-suctioning device may be a smoke-suctioning device (or a smoke-suctioning system, respectively).

In previously known vehicles, in particular previously known rail vehicles, suctioning lines of smoke-detection devices are placed in the empty space between the vehicle body-shell ceiling and the interior ceiling, for example, so as to visually obscure said suctioning lines from the vehicle passengers.

The invention is based on the object of providing a vehicle in which a more favorable routing of the suctioning lines than in previous vehicles is achieved.

This object is achieved according to the invention by a vehicle having the features according to patent claim 1. Advantageous design embodiments of the vehicle according to the invention are stated in dependent claims.

It is accordingly provided according to the invention that at least one portion of a suctioning line of the gas-suctioning device is routed through, held on, or formed by a baggage-rack element which is fitted in the interior of the vehicle.

A significant advantage of the vehicle according to the invention is to be seen in that the baggage-rack elements which typically anyway exist for depositing baggage in vehicles are utilized for two reasons, namely for their primary function of storing baggage as well as additionally for indirectly or directly directing gas, in particular smoke. On account of this two-fold utilization it is no longer necessary for suctioning lines to be disposed in the already mentioned empty space between the body-shell ceiling and the interior ceiling, such that this empty space may either be reduced while increasing the height of the interior space or be used for installing other lines.

A further significant advantage of the vehicle according to the invention lies in that in the case of routing suctioning lines in the region of baggage-rack elements the complexity in installing and optionally repairing or maintaining the suctioning lines is minimized, respectively.

As has already been mentioned, the gas-suctioning device may be employed for smoke-detection devices; it is accordingly considered advantageous for the vehicle to have a smoke-detection device which is connected to the described gas-suctioning device or comprises the latter as a component part. The smoke-detection device preferably has a smoke-gas detector which examines the gas which has been suctioned by the gas-suctioning device for the presence of smoke-gas particles and in the event of smoke gas being present or of a predefined smoke-gas concentration being exceeded, generates a warning signal.

The gas-suctioning device preferably suctions interior air which is located in the vehicle, for example interior air from the passenger cabin or the passenger compartments; alternatively, the gas-suctioning device may also suction air from drive compartments or other operational spaces of the vehicle which are equipped with technical equipment.

The gas-suctioning device is preferably designed such that during operation of the gas-suctioning device gas is directed through a pipe of the baggage-rack element.

It is considered particularly advantageous for the pipe of the baggage-rack element per se to form a portion of the suctioning line. In such a design embodiment, an additional suctioning line in the region of the baggage-rack element may be completely dispensed with, as the baggage-rack element per se serves as the suctioning line. The costs for installing the gas-suctioning device may thus be minimized.

Gas-suctioning openings are preferably fitted to or integrated into the baggage-rack element, or are formed by outlet portions (in the form of holes or bores, for example) of the baggage-rack element.

Alternatively, it may be provided that the suctioning line comprises a gas hose or a gas pipe which is routed through the pipe of the baggage-rack element. In this design embodiment the baggage-rack element by way of the pipe thereof protects an additional and internally routed suctioning line, without said baggage-rack element itself being in contact with gas. This embodiment is a type of double-walled routing of the gas in the region of the baggage-rack element. Also in this variant, gas-suctioning openings are preferably fitted to or integrated into the baggage-rack element, or are formed by outlet portions (in the form of holes or bores, for example) of the baggage-rack element.

It is considered particularly advantageous for the baggage-rack element to be an extruded part in which an extruded pipe extends in the extrusion direction of the extruded part, and for the extruded pipe to form said pipe for forming or receiving the suctioning line.

The extruded part is preferably oriented such that the extrusion direction thereof is parallel with the vehicle longitudinal direction.

Additionally or alternatively, it may be provided that the baggage-rack element has a receptacle portion in which a portion of a suctioning line of the gas-suctioning device is installed and by which the portion of the suctioning line is held. In this embodiment the receptacle portion serves for supporting or obscuring the suctioning line, respectively, without carrying gas per se.

In the last-mentioned embodiment it is thus considered advantageous for the receptacle portion together with the suctioning line installed therein to be shut off from the outside by a cover element. On account of the receptacle portion being shut off from the outside it may be ensured that the suctioning line is not visible from the outside; this is advantageous in particular for aesthetic reasons. Such a cover element is preferably formed by the interior cladding in the vehicle interior, the body-shell wall, or the ceiling of the vehicle.

Also in the case of the last-mentioned embodiment gas-suctioning openings are preferably fitted to or integrated into the baggage-rack element, or are formed by outlet portions (in the form of holes or bores, for example) of the baggage-rack element.

If the baggage-rack element is an extruded part, it is considered advantageous for the receptacle portion to extend in the longitudinal extrusion direction of the baggage-rack element.

The invention moreover relates to a baggage-rack element for a vehicle, as has been described above. It is provided according to the invention that the baggage-rack element is suitable for holding, routing, or forming a suctioning line of a gas-suctioning device. With reference to the advantages of the baggage-rack element according to the invention, reference is made to the above explanations in the context of the vehicle according to the invention.

The invention furthermore relates to an assembly having a gas-suctioning device, a smoke-gas detector, and a baggage-rack element. It is provided according to the invention that at least one portion of a suctioning line of the gas-suctioning device is routed through, held on, or formed by the baggage-rack element of a vehicle.

The invention moreover relates to a method for operating a gas-suctioning device for suctioning gas which is located in a vehicle, in particular a rail vehicle. With reference to such a method it is provided according to the invention that for suctioning gas, gas is directed through at least one portion of a suctioning line which is routed through, held on, or formed by a baggage-rack element which is fitted in the interior.

With reference to the advantages of the method according to the invention, reference is made to the above explanations in the context of the vehicle according to the invention, since the advantages of the vehicle according to the invention substantially correspond to those of the method according to the invention.

According to one advantageous design embodiment of the method it is provided that the suctioned gas is examined for the presence of smoke-gas particles and a warning signal is generated when the suctioned gas contains smoke-gas particles or the proportion of smoke-gas particles exceeds a predefined threshold.

The invention will be explained in more detail hereunder by means of exemplary embodiments. In the figures:

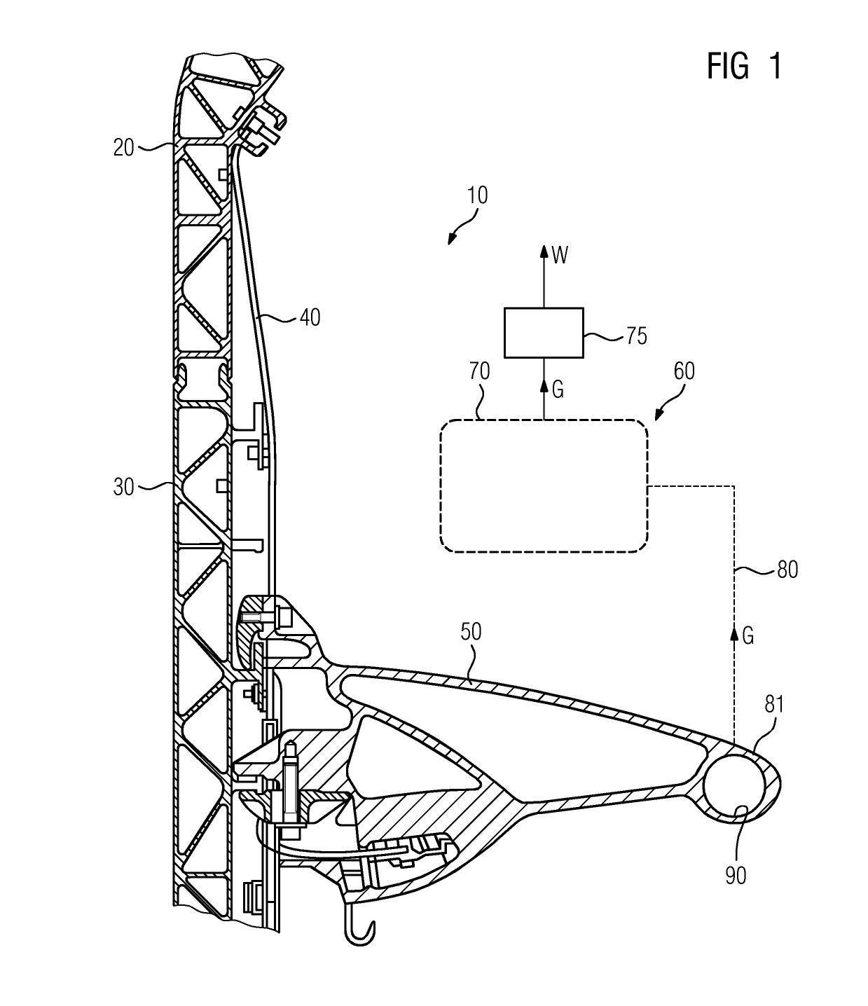

FIG. 1 shows an exemplary embodiment for a vehicle, in which a portion of a suctioning line of a smoke-detection device is formed by a pipe of a baggage-rack element;

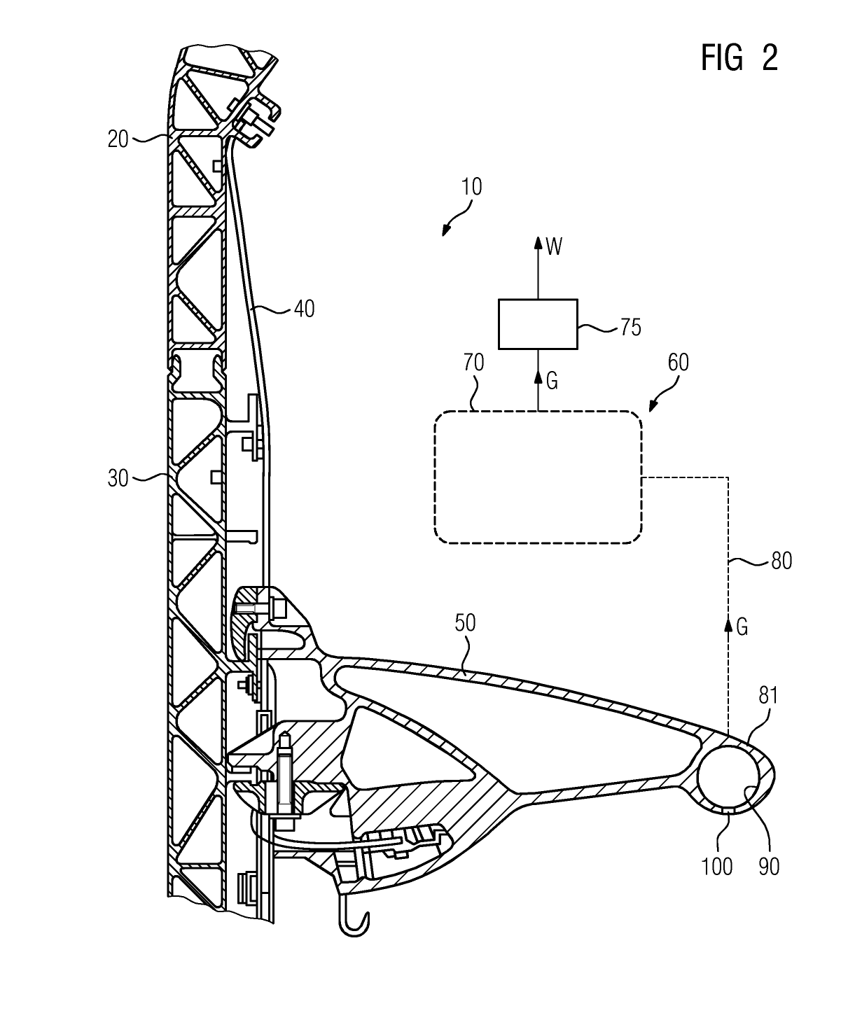

FIG. 2 shows an exemplary embodiment for a vehicle, in which a portion of a suctioning line of a smoke-detection device is formed by a pipe of a baggage-rack element, and gas-suctioning openings are fitted in the baggage-rack element;

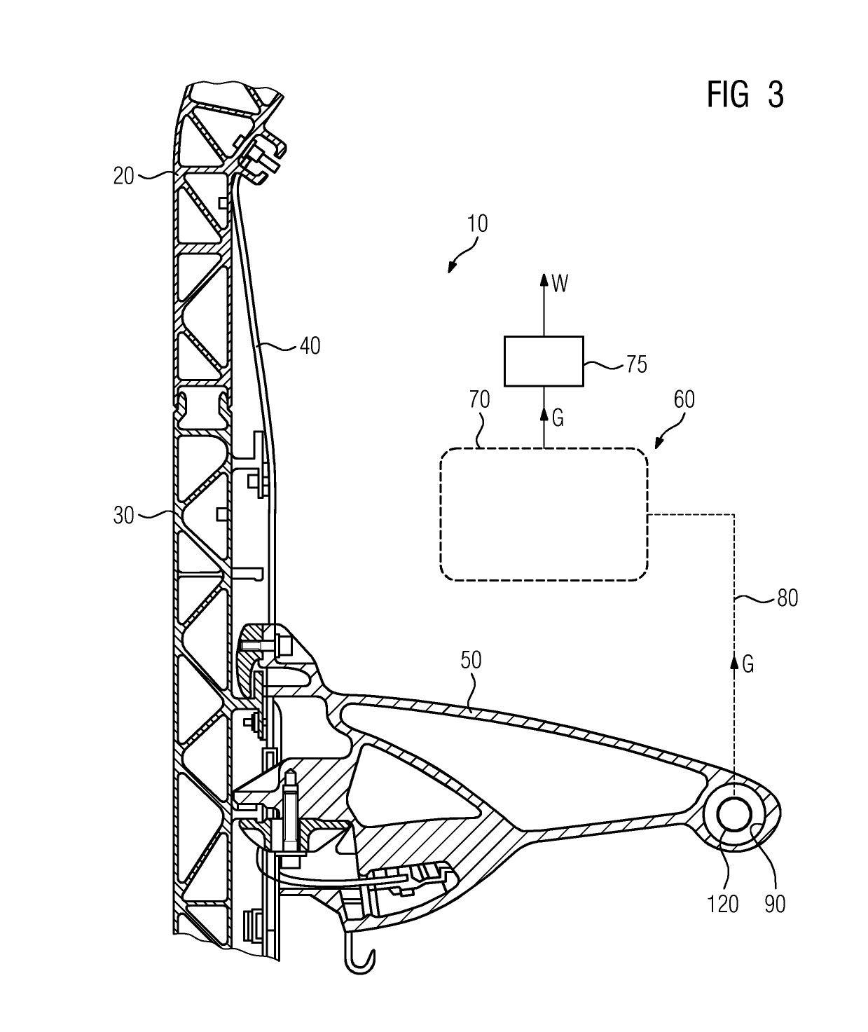

FIG. 3 shows an exemplary embodiment for a vehicle, in which a portion of a suctioning line of a smoke-detection device is formed by a gas hose or a gas pipe which is routed through a pipe of a baggage-rack element;

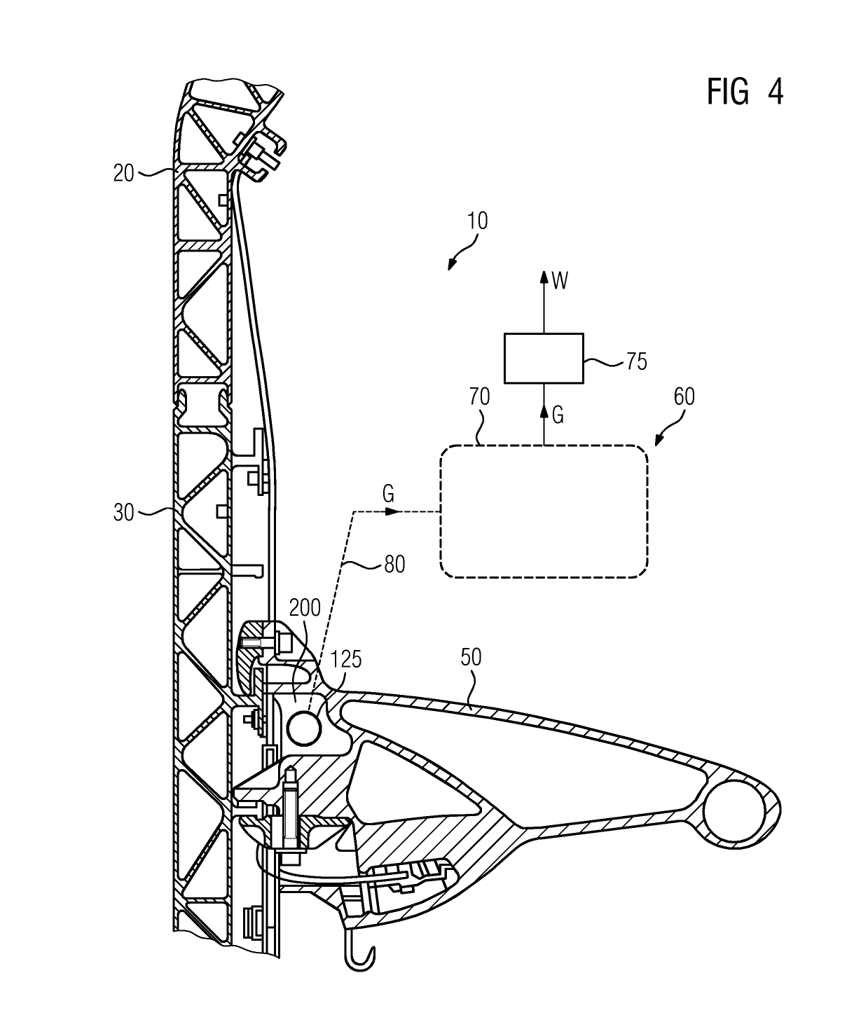

FIG. 4 shows an exemplary embodiment for a vehicle in which a portion of a suctioning line of a smoke-detection device is held by a receptacle portion of a baggage-rack element;

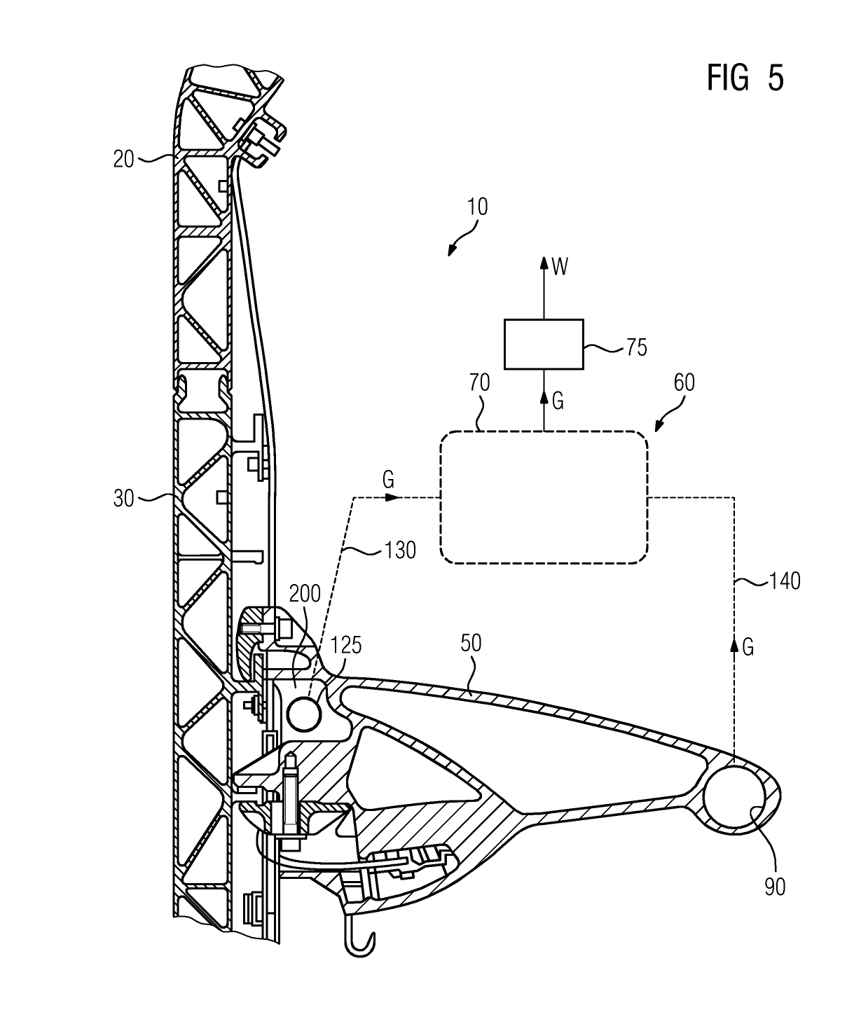

FIG. 5 shows an exemplary embodiment for a vehicle, in which a smoke-detection device comprises two suctioning lines of which one suctioning line is formed by a pipe of a baggage-rack element and a second suctioning line is installed in a receptacle portion of the same baggage-rack element and is held thereby; and

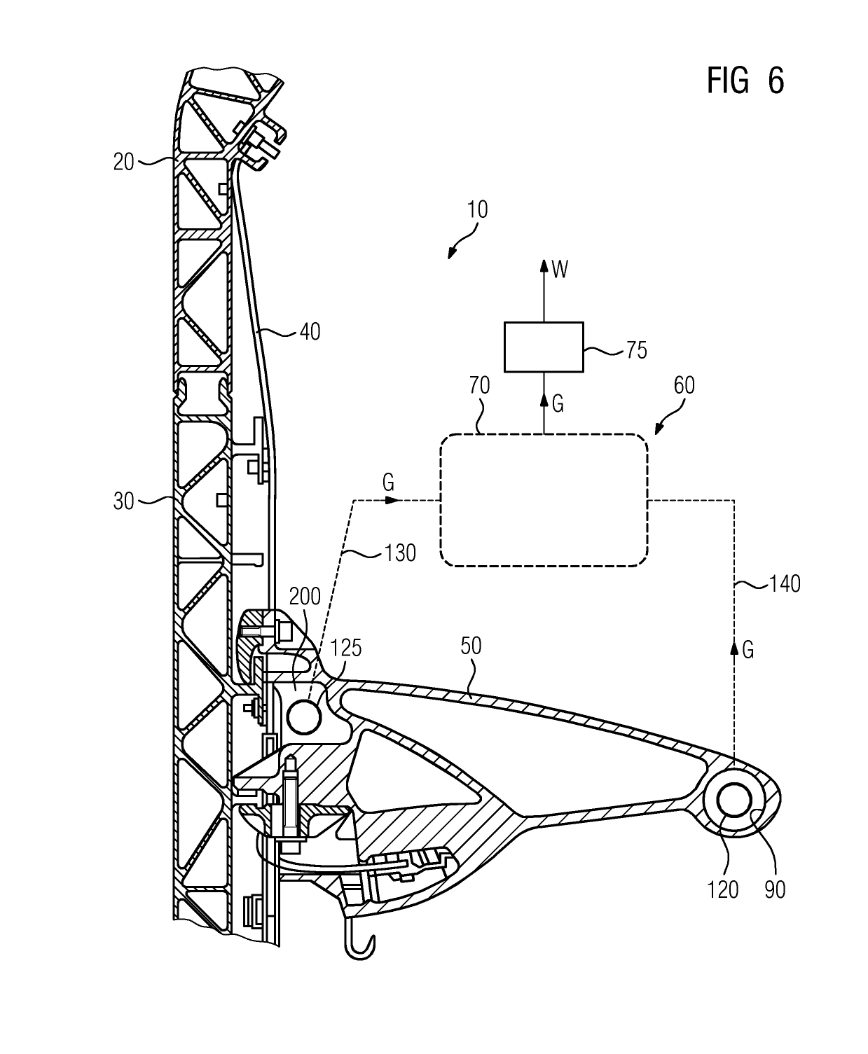

FIG. 6 shows an exemplary embodiment for a vehicle, in which a smoke-detection device comprises two suctioning lines of which one suctioning line in portions is routed through a pipe of a baggage-rack element, without being formed by the pipe, and a second suctioning line is installed in a receptacle portion of the same baggage-rack element and is held thereby.

For the sake of clarity, the same reference signs are used throughout in the figures for equivalent or identical components.

FIG. 1 shows an interior 10 of a vehicle 20 which is shown only in portions and which may be a rail vehicle, for example. A body-shell wall 30 of the vehicle 20, which for visual or aesthetic reasons, respectively, is provided with an interior cladding 40, can be seen.

A baggage-rack element 50 is fitted to the body-shell wall 30, the former preferably being an extruded part. The extrusion direction of the extruded part is oriented along the longitudinal direction of the vehicle 20. The extrusion direction of the extruded part or of the baggage-rack element 50, respectively, thus is perpendicular to the image plane of FIG. 1, since the longitudinal direction of the vehicle 20 in the illustration according to FIG. 1 is also oriented so as to be perpendicular to the image plane.

The vehicle 20 is equipped with a smoke-detection device 60 which suctions gas G, for example interior air from the interior 10, examines the latter for smoke gas, and in the event of a vehicle fire or of an excessive concentration of smoke gas, respectively, generates a warning signal W. The smoke-detection device 60 comprises a gas-suctioning device 70 and a smoke-gas detector 75 which is supplied with gas G by the gas-suctioning device 70. The gas-suctioning device 70 comprises a suctioning line 80 which at least in portions conveys gas G through the interior 10 in the direction of the smoke-gas detector 75.

In the exemplary embodiment according to FIG. 1, a portion 81 of the suctioning line 80 is formed by a pipe 90 of the baggage-rack element 50. The pipe 90 is an extruded pipe which has been formed during extrusion of the baggage-rack element 50 and extends along the extrusion direction of the baggage-rack element 50, or along the longitudinal direction of the vehicle 20, respectively. In the exemplary embodiment according to FIG. 1, the pipe 90 of the baggage-rack element 50 thus forms the portion 81 of the suctioning line 80 per se, without the suctioning line 80 in the region of the baggage-rack element 50 having to have further components, for example a pipe, or a hose, or similar.

During operation thereof, the smoke-detection device 60 by means of the gas-suctioning device 70 will suction gas G (for example interior air from the vehicle interior 10) through gas-suctioning openings (not shown in FIG. 1) and at least in portions direct said gas G through the interior 10 to the smoke-gas detector 75 which examines the gas and optionally generates the warning signal W.

The gas-suctioning openings may be fitted to, integrated into or formed by the baggage-rack element 50, for example.

FIG. 2 shows in an exemplary manner a vehicle 20 which substantially corresponds to the vehicle 20 according to FIG. 1. It differs from the vehicle 20 according to FIG. 1 in that the pipe 90 of the baggage-rack element 50 forms the gas-suctioning openings which have already been mentioned in the context of FIG. 1 and through which gas G is suctioned and may make its way to the smoke-gas detector 75; in FIG. 2 the gas-suctioning openings are identified by the reference sign 100.

Gas-suctioning openings 100 of this type are preferably formed by bores which are introduced into the pipe 90 of the baggage-rack element 50 after extrusion. During operation of the smoke-detection device 60, the pipe 90 of the baggage-rack element 50 thus performs two functions. On the one hand, said pipe 90 serves for directing gas G through the interior 10 in a manner which is perpendicular to the image plane of FIG. 1, and on the other hand, said pipe 90, by means of the gas-suctioning openings 100 which are provided in the pipe 90, serves for suctioning gas G from the interior 10.

FIG. 3 shows a further exemplary embodiment for a vehicle 20 which is equipped with a smoke-detection device 60 and a baggage-rack element 50. The baggage-rack element 50 is fastened to the body-shell wall 30, as has already been explained in the context of FIG. 1. The smoke-detection device 60 comprises a suctioning line 80 which in portions is formed by a gas hose or a gas pipe 120 which is routed through the pipe 90 of the baggage-rack element 50.

In the exemplary embodiment according to FIG. 3, gas G is thus not directly directed through the pipe 90 of the baggage-rack element 50 per se, but is indirectly directed there through, since the directing of gas G is performed through the gas hose or the gas pipe 120, respectively, of the smoke-detection device 60, and the pipe 90 serves for supporting and protecting the gas hose or the gas pipe 120, respectively.

FIG. 4 shows a further exemplary embodiment for a vehicle 20 in the interior 10 of which a baggage-rack element 50 is fitted to a body-shell wall 30. A smoke-detection device 60, the suctioning line 80 of which in portions is formed by a gas hose or a gas pipe 125 which is installed in a receptacle portion 200 of the baggage-rack element 50 and is held by said receptacle portion 200, can be seen in FIG. 4. The exemplary embodiment according to FIG. 4 otherwise corresponds to the exemplary embodiments according to FIGS. 1 to 3.

FIG. 5 shows a further exemplary embodiment for a vehicle 20 in the interior 10 of which a baggage-rack element 50 is fitted to a body-shell wall 30. A smoke-detection device 60 which comprises a gas-suctioning device 70 and two suctioning lines 130 and 140 can be seen in FIG. 5. The two suctioning lines 130 and 140 serve for conveying gas G from gas-suctioning openings (not illustrated in FIG. 5).

It can be seen in FIG. 5 that the suctioning line 130 in portions is formed by a gas hose or a gas pipe 125 which is installed in a receptacle portion 200 of the baggage-rack element 50 and is held by said receptacle portion 200. The other suctioning line 140 is formed by a pipe 90 of the baggage-rack element 50 which extends in a perpendicular manner to the image plane of FIG. 5.

The baggage-rack element 50 is preferably an extruded part, such that the pipe 90 of the baggage-rack element 50 is formed by an extruded pipe and the receptacle portion 200 is formed by the shape of the extruded part. In the illustration according to FIG. 5, the longitudinal direction of the extruded pipe 90 and that of the receptacle portion 200, or the extrusion direction of the baggage-rack element 50, respectively, extend in a perpendicular manner to the image plane of FIG. 4 and thus along the longitudinal direction of the vehicle 20.

During operation of the gas-suctioning device gas G, for example air from the interior 10, is suctioned through gas-suctioning openings (not illustrated in FIG. 4) and directed through the two suctioning lines 130 and 140 to the smoke-gas detector 75, in order for the latter to be able to examine the gas and optionally generate the warning signal W. Gas-suctioning openings of this type are preferably also provided at least in or on the pipe 90 of the baggage-rack element 50, for example in that holes are bored into the extruded pipe 90. With reference thereto, reference is made to the above explanations in the context of FIG. 2.

FIG. 6 shows an exemplary embodiment for a vehicle 20 of which the smoke-detection device 60 substantially corresponds to the smoke-detection device 60 according to FIG. 5. The smoke-detection device 60 according to FIG. 6 also has two suctioning lines 130 and 140 which are routed through or held by the baggage-rack element 50. It can thus be seen that the suctioning line 130 in portions is held in the receptacle portion 200 of the baggage-rack element 50, as has already been mentioned in the context of FIG. 5.

The design of the suctioning line 140 of the smoke-detection device 60 however differs from the design of the suctioning line 140 according to FIG. 5. It can thus be seen in FIG. 6 that the suctioning line 140 is formed by a gas hose or a gas pipe 120 which has been routed through the pipe 90 of the baggage-rack element 50. With reference to the suctioning line 140, the embodiment according to FIG. 6 is thus similar to the embodiment according to FIG. 3.

While the invention has been visualized and described in more detail by way of preferred exemplary embodiments, the invention is not limited to the disclosed examples, and other variants may be derived there from by a person skilled in the art without departing from the scope of protection of the invention.

1-15. (canceled)

16. A vehicle, comprising:
a baggage-rack element fitted in an interior of the vehicle;
a gas-suctioning device for suctioning gas located in the vehicle;
said gas-suctioning device having a suctioning line; and
at least one portion of said suctioning line being routed through, held on, or formed by said baggage-rack element.

17. The vehicle according to claim 16, which further comprises:
a smoke-detection device, said smoke-detection device being connected to said gas-suctioning device or said gas-suctioning device being a component part of said smoke-detection device; and
said smoke-detection device examining gas having been suctioned by said gas-suctioning device for a presence of smoke-gas particles and generating a warning signal if smoke gas is present or if a predefined smoke-gas concentration is exceeded.

18. The vehicle according to claim 17, wherein said gas-suctioning device suctions interior air located in the vehicle.

19. The vehicle according to claim 16, wherein said baggage-rack element has a pipe, and said gas-suctioning device directs gas through said pipe during operation of said gas-suctioning device.

20. The vehicle according to claim 19, wherein said pipe of said baggage-rack element forms said at least one portion of said suctioning line.

21. The vehicle according to claim 19, wherein said suctioning line includes a gas hose or pipe routed through said pipe of said baggage-rack element.

22. The vehicle according to claim 16, wherein:
said baggage-rack element is an extruded part in which an extruded pipe (90) extends in an extrusion direction of said extruded part; and
said extruded pipe forms a pipe forming or receiving said suctioning line.

23. The vehicle according to claim 16, wherein at least one gas-suctioning opening is fitted to or integrated into said baggage-rack element or is formed by an outlet portion of said baggage-rack element.

24. The vehicle according to claim 17, wherein said baggage-rack element has a receptacle portion in which a portion of said suctioning line of said gas-suctioning device is installed and said receptacle portion holds said portion of said suctioning line.

25. The vehicle according to claim 24, which further comprises a cover element shutting off said receptacle portion together with said suctioning line installed therein from the outside.

26. The vehicle according to claim 25, wherein said cover element is formed by a body-shell wall, a body-shell ceiling, an interior cladding or an interior ceiling of the vehicle.

27. The vehicle according to claim 24, wherein said baggage-rack element is an extruded part in which said receptacle portion extends in a longitudinal extrusion direction.

28. The vehicle according to claim 16, wherein the vehicle is a rail vehicle.

29. An assembly, comprising:
a smoke-gas detector;
a baggage-rack element; and
a gas-suctioning device having a suctioning line, at least one portion of said suctioning line being routed through, held on, or formed by said baggage-rack element.

30. A method for operating a gas-suctioning device for suctioning gas located in a vehicle, the method comprising the following steps:
providing a baggage-rack element fitted in an interior of the vehicle;
providing a suctioning line routed through, held on, or formed by the baggage-rack element; and
suctioning the gas through at least one portion of the suctioning line.

31. The method according to claim 30, wherein the vehicle is a rail vehicle.

32. The method according to claim 30, which further comprises:
examining the suctioned gas for a presence of smoke-gas particles; and
generating a warning signal if the suctioned gas contains smoke-gas particles or if a proportion of smoke-gas particles exceeds a predefined threshold.
